(19) United States
(12) Patent Application Publication
(10) Pub. No.: US 2017/0169346 A1
(43) Pub. Date: Jun. 15, 2017

(54) Methods and Apparatus for Sequence Recognition Using Sparse Distributed Codes

(71) Applicant: Gerard John Rinkus, Newton, MA (US)

(72) Inventor: Gerard John Rinkus, Newton, MA (US)

(21) Appl. No.: 15/379,388

(22) Filed: Dec. 14, 2016

Related U.S. Application Data
(60) Provisional application No. 62/267,140, filed on Dec. 14, 2015.

(51) Int. Cl. G06N 5/04; G06N 7/00; G06N 99/00

(52) U.S. Cl. CPC G06N 5/047; G06N 99/005; G06N 7/005

(57) ABSTRACT

The invention is methods and apparatus for: a) performing nonlinear time warp invariant sequence recognition using a back-off procedure; and b) recognizing complex sequences, using physically embodied computer memories that represent information using a sparse distributed representational (SDR) format. Recognition of complex sequences often requires that multiple equally plausible hypotheses (multiple competing hypotheses, MCHs) can be simultaneously physically active in memory until disambiguating information arrives whereupon only hypotheses that are consistent with the new information are active. The invention is the first description of both back-off and MCH-handling methods in combination with representing information using a sparse distributed representation (SDR) format.

### REFERENCE TO RELATED APPLICATION

This application claims the benefit of the filing date, under 35 U.S.C. 119, of U.S. Provisional Application No. 62/267,140, filed on Dec. 14, 2015, the entire content of which, including all the drawings thereof, are incorporated here by reference.

### GOVERNMENT SUPPORT

The invention described herein in partly supported by DARPA Contract FA8650-13-C-7462. The U.S. Government has certain rights in this invention.

### BACKGROUND OF THE INVENTION

Sparsey (Rinkus 1996, Rinkus 2010, Rinkus 2014) is a class of machines that is able to learn, both autonomously and under supervision, the statistics of a general class of spatiotemporal pattern domains and recognize, recall and predict patterns, both known and novel, from such domains. The domain is the class of discrete binary multivariate time series (DBMTS). For simplicity, the class of DBMTSs is referred to herein simply as the class of “sequences.”

A Sparsey machine instance is a hierarchical network of interconnected coding fields, Mᵢ. The term “mac” (short, for “macrocolumn”) is used herein interchangeably with “coding field”, and also with “memory module”, in particular, in the Claims. An essential feature of Sparsey is that its macs represent information in the form of sparse distributed representations (SDR). It is exceedingly important to understand that SDR is not the same concept as “sparse coding” (Olshausen and Field 1996, Olshausen and Field 1996, Olshausen and Field 2004), which unfortunately is often mislabeled as SDR (or similar phrases) in the relevant literatures: SDR≠“sparse coding” (though they are entirely compatible). In particular, the SDR format used in Sparsey is as shown in FIG. 1. The mac 100 consists of Q competitive modules (CMs) 101, each of which consists of K representational units (“units”) 102. All codes consist of one active unit per CM; thus this is a fixed-size SDR format, where all codes are of size Q. Codes are denoted herein using the Greek letter, θ.

Seven CMs (Q=7), each including seven units (K=7) are shown in FIG. 1. However, it should be appreciated that any suitable number of CMs and units may alternatively be used. The CMs function in winner-take-all (WTA) fashion: only one unit per CM can be active in any code. A mac is able to store multiple SDR codes. Each such code is a representation of a particular sequence that has been presented as input to the mac. Sparsey's method for assigning codes to input sequences is called the code selection algorithm (CSA), an example of which is described in Table 1.¹ The CSA preserves similarity, i.e., similar sequences are mapped to similar codes (SISC). The measure of code similarity is size of intersection (overlap). Thus, the particular code φ_{X} active in response to a presentation of sequence X, represents:

a) that particular sequence, X, and

b) a similarity distribution over all codes stored in the mac, and by SISC, also a similarity distribution over the sequences that those codes represent. ¹ The mac and CSA are heavily parameterized. The specific variant/parameters may vary across macs comprising a given Sparsey instance and through time during operation.

The similarity distribution can equally well be considered to be a likelihood distribution over the sequences, qua hypotheses, stored in the mac. The terms “similarity distribution” and “likelihood distribution” are used interchangeably herein.

Thus, the act of choosing (activating) a particular code is, at the same time, the act of choosing (activating) an entire distribution over all stored codes. The time it takes for the mac to choose a particular distribution does not depend on the number of codes stored, i.e., in the size of the distribution.

One step in a mac's determination of which code to activate when given an input is multiplicatively combining multiple evidence sources, each of which can thus be referred to as a factor. These factors are vectors over the units comprising the mac and the multiplication is element-wise. In some embodiments, e.g., FIG. 2, macs have three evidence sources, one carrying “top-down” (D) signals from macs at higher levels, one carrying “bottom-up” (U) signals from lower level macs or from input level units which are not organized as macs, and one carrying “horizontal” (H) signals from other macs in the same level. But, in other embodiments, an arbitrary number of input sources are allowed, e.g., carrying signals from other modalities. Furthermore, any of the D, U, and H, or any other sources, can be further decomposed into factors. Let the vector V, also over the units comprising the mac, denote the product of the factors. V is simultaneously:

a) an estimate of the likelihood, also referred to as the “support” (given all the evidence sources) of a particular code′ [which may be referred to as the most similar, or most likely, code (and there may be multiple codes tied for maximum similarity)]. and
b) an estimate of the entire similarity (likelihood) distribution over all codes. ² The reason why V is considered to be an estimate of a particular code is that the CSA mandates that the number of units activated in a mac is always Q. It is generally possible, and in fact a frequent occurrence during learning [or more generally, in unfamiliar moments (i.e., when G is low)], that the set of units activated, though always of size Q, will not be identical to any previously stored code. However, it is also generally possible, and in fact a frequent occurrence [in familiar moments (i.e., when G is near 1)], that the set of units activated is identical to a previously stored (i.e., known) code. It is worthwhile to understand the CSA in the following way. The decision process it implements operates at a finer granularity than that of whole codes (i.e., whole hypotheses), an operating mode which has often been referred to in neural net/connectionist literatures as “sub-symbolic” processing, i.e., where “symbol” can here be equated with “hypothesis” or “code”.

TABLE 1
The CSA

| | Equation | |
|---|---|---|
| 1 | $Active ( m ) = \{ \begin{matrix}true & ϒ ( m ) < δ ( m ) \\ true & {π}_{U}^{-} \leq {π}_{U} ( m ) \leq {π}_{U}^{+} \\ false & otherwise\end{matrix}$ | Determine if mac m will become active. |
| 2 | u(i) = Σ_{jεRF}_{_{U}} x(j, t) × F(ζ(j, t)) × w(j, i) | Compute the raw U, H, and D |
| | h(i) = Σ_{jεRF}_{_{H}} x(j, t − 1) × F(ζ(j, t − 1)) × w(j, i) | input summations. |
| | d(i) = Σ_{jεRF}_{_{D}} x(j, t − 1) × F(ζ(j, t − 1)) × w(j, i) | |
| 3 | $U ( i ) = \{ \begin{matrix}max ( 1 , u ( i ) / {π}_{U}^{-} \times {w}_{max} ) & L = 1 \\ max ( 1 , u ( i ) / min ( {π}_{U}^{-} , {π}_{U}^{*} ) \times Q \times {w}_{max} ) & L > 1\end{matrix} \\ H ( i ) = max ( 1 , h ( i ) / min ( {π}_{H}^{-} , {π}_{H}^{*} ) \times Q \times {w}_{max} ) \\ D ( i ) = max ( 1 , d ( i ) / min ( {π}_{D}^{-} , {π}_{D}^{*} ) \times Q \times {w}_{max} )$ | Compute normalized, filtered input summations. |
| 4 | $V ( i ) = \{ \begin{matrix}{H ( i )}^{{λ}_{H}} \times {U ( i )}^{{λ}_{U} ( t )} \times {D ( i )}^{{λ}_{D}} & t \geq 1 \\ {U ( i )}^{{λ}_{U} ( 0 )} & t = 0\end{matrix}$ | Compute local evidential support for each cell. |
| 5a | ζ_{q} = Σᵢ₌₀^{K}[V(i) > V_{ζ}] | (a) Compute # cells representing |
| 5b | ζ = Σⱼ₌₀^{Q-1}ζ_{q}/Q | a maximally competing |
| | | hypothesis in each CM. (b) |
| | | Compute # of maximally active |
| | | hypotheses, ζ, in the mac. |
| 6 | $F ( ζ ) = \{ \begin{matrix}{ζ}^{A} & 1 \leq ζ \leq B \\ 0 & ζ > B\end{matrix}$ | Compute the multiple competing hypotheses (MCH) correction factor, F(ζ), for the mac. |
| 7 | \hat{V}ⱼ = max_{iεC}_{ⱼ} {V(i)} | Find the max V, \hat{V}ⱼ, in each CM, |
| | | Cⱼ. |
| 8 | G = Σ_{q = 1}^{Q}\hat{V}ₖ/Q | Compute G as the average \hat{V} |
| | | value over the Q CMs. |
| 9 | $η = 1 + {( {[ \frac{G - {G}^{-}}{1 - {G}^{-}} ]}^{+} )}^{γ} \times χ \times K$ | Determine the expansivity of the sigmoid activation function. |
| 10 | $ψ ( i ) = \frac{( η - 1 )}{{( 1 + {σ}_{1} {e}^{- {σ}_{2} ( V ( i ) - {σ}_{3} )} )}^{{σ}_{4}}} + 1$ | Apply sigmoid activation function (which collapses to the constant function when G < G⁻) to each |
| | | cell. |
| 11 | $ρ ( i ) = \frac{ψ ( i )}{{\sum }_{k ∈ CM} {ψ}^{( k )}}$ | In each CM, normalize the relative probabilities of winning (ψ) to final probabilities (ρ) of winning. |

| | |
|---|---|
| 12 | Select a final winner in each CM according to the ρ distribution in that CM, i.e., soft |
| | max. |

As discussed above, a Sparsey machine instance is a hierarchical network of interconnected macs, a simple example of which is shown in FIG. 2. FIG. 2 shows that the inputs to a mac 203 can be divided into three classes:

a) Bottom-up (U) input 204: either from the input level or from subjacent internal levels which are themselves composed of macs

b) Top-down (D) input 201: from higher levels, which are composed of macs

c) Horizontal (H) inputs 202: from itself or from other macs at its level.

The set of input sources, either pixels [for the case of macs at the first internal level (L1)] or level J−1 macs (for the case of macs at levels L2 and higher), to a level J mac, M, are denoted as M's “U receptive field”, or “RF_{U}”. The set of level J macs providing inputs to a given level J mac, M, are denoted as M's “H receptive field”, or “RF_{H}”. The set of level J+1 macs providing inputs to a given level J mac, M, are denoted as M's “D receptive field”, or “RF_{D}”. These three classes are considered as separate evidence sources, and are combined multiplicatively in CSA Step 4 (see Table 1). Connections to only one cell within the coding field are shown, and all cells in the coding field have connections from the same set of afferent cells. However, it should be appreciated that more complex arrangements may also be used, and the coding field shown in FIG. 2 is provided merely for illustrative purposes. For example, some implementations of Sparsey allow that the units of a mac need not have exactly the same set of afferent units.

As noted above, in other implementations of Sparsey, the number of classes of input (evidence sources) can be more than three. The evidence sources can come from any sensory modality whose information can be transformed into DBMTS format. The particular set of inputs can vary across macs at any one level and across levels.

In one envisioned usage scenario, a Sparsey machine will, at any given time, be mandated to be operating in either training (learning) mode or retrieval mode. Typically, it will first operate in learning mode in which it is presented with some number of inputs, e.g., input sequences, and various of its internal weights are increased, as a record or memory of the specific inputs and of higher-order correlational patterns over the inputs. That is, the synaptic weights are explicitly allowed to change when in learning mode. The machine may then be operated in a retrieval mode in which inputs, i.e. sequences, either known or novel, are presented—referred to as “test” inputs—and the machine either recognizes the inputs, or recalls (predicts) portions of those inputs given prompts (which may be subsets, e.g., sub-sequences) of inputs in the training set. Weights are not allowed to change in retrieval mode. In general, a Sparsey machine may undergo multiple temporally interleaved training and retrieval phases.

In general, a mac, M, will not be active on every time step of the overall machine's operation. The decision as to whether a mac activates occurs in CSA Step 1. On every time step on which M is active, it computes a measure, G, which is a measure of how familiar or novel M's total input is. M's total input at time T consists of all signals arriving at M via all of its input sources, i.e. all active pixels or macs in its RF_{U}, all previously (at T−1) active macs in its RF_{H}, and all previously (and possibly also currently) active macs in its RF_{D}. G can vary between 0 (completely unfamiliar) and 1 (completely familiar).

A G measure close to 1.0 indicates that M senses a high degree of familiarity of its current total input. In that case, M is said to be operating in retrieval mode. That is, if it senses high familiarity it is because the current total input is very similar or identical to at least one total input experienced on some prior occasion(s). In that case, the CSA will act to reactivate the stored code(s) that were assigned to represent that at least one total input on the associated prior occasions. On the other hand, if G is close to 0, that indicates that the mac's current total input is not similar to any stored total input. Since the mac has been activated (in CSA Step 1), it will still activate a code (one unit per CM), but the actions of CSA Steps 9 and 10 will cause, with high likelihood, activation of a code that is different from any stored code. In other words, the mac will effectively be assigning a new code to a novel total input. In that case, M is said to be operating in learning (training) mode.

Thus, in addition to the imposition of an overarching mandated operating mode, every individual mac also computes a signal, G, whenever it is active, which automatically modulates the code selection dynamics in a way that is consistent with such a mandated mode. That is, because the code activated in M when G is near 0 will, with very high likelihood, be different from any code previously stored in M, there will generally be synapses from units in the codes comprising M's total input onto units in the newly activated novel code, which either have never been increased or for other reasons (including passive decay due to inactivity) are at sub-maximal strength. The weights of such synapses will be increased to the maximal possible value in this instance. In contrast, if G is near 1, the code activated will likely be identical or very close to the code that was activated on the prior occasion when M's total input was the same as it is in the current instance. Thus there will be none or relatively few synapses that have not already been increased. Nevertheless, even in this case, all active afferent synapses will be increased to their maximum possible value (as further elaborated below).

If a Sparsey machine instance is in learning mode, learning proceeds in the following way. Suppose a mac M^{β}, which has three input sources, U, H, and D, is activated with code φ^{β}. Then the weights of all synapses from the active units comprising the codes active in all afferent macs in M^{β}'s RF_{U}, RF_{H}, and RF_{D}, onto all active units in φ^{β} will be increased to their maximal value (if not already at their maximal value). In the special case where M^{β} is at the first internal level (L1), the U-wts from all active units (e.g., pixels) in its RF_{U} will be increased (if not already at their maximal value). Let M^{α} be one such active mac in one of M^{β}'s RFs, and let its active code be φ^{α}. Then the terminology that φ^{α} becomes “associatively linked”, or just “associated”, to φ^{β} may be used. In some cases, increases to weights from units in any single one of M^{β}'s particular RFs, RFⱼ, are disallowed if the total fraction of weights in RFⱼ has reached a threshold specific to RFⱼ. We refer to these thresholds as “freezing thresholds”. They are needed in order to prevent too large a fraction of the weights comprising an RF to be set to their maximal value, since as that fraction goes to 1, i.e., as the weight matrix becomes “saturated”, the information it contains drops towards zero. Typically, these thresholds are set in the 20-50% region, but other settings are possible depending on the specific needs of the task/problem and other parameters.

In general, the convention for learning in the three classes of input U, H, and D, are as follows. For U-wts, the learning takes place between concurrently active codes. That is, if a level J mac, M^{β}, is active at time S, with code, φ_{S}^{β}, then codes active at S in all level J−1 macs in M^{β}'s RF_{U} will become associated with φ_{S}^{β}. For H-wts, the learning takes place between successively active codes. That is, if a level J mac, M^{β}, is active at time S, with code, φ_{S}^{β}, then codes active at S−1 in all level J macs in M^{β}'s RF_{H} (which may include itself), will become associated with φ_{S}^{β}. For D-wts, there are multiple possible embodiments. The D-wts may use the same convention as the H-wts: if a level J mac, M^{β}, is active at time S, with code, φ_{S}^{β}, then codes active at S−1 in all level J+1 macs in M^{β}'s RF_{D}, will become associated with φ_{S}^{β}. Alternatively, learning in the D-wts may also occur between concurrently active macs as well. In this case, if a level J mac, M^{β}, is active at time S, with code, φ_{S}^{β}, then codes active at either S−1 or S in all level J+1 macs in M^{β}'s RF_{D}, will become associated with φ_{S}^{β}.

### SUMMARY OF THE INVENTION

Sequence recognition systems (e.g., Sparsey) often operate on input sequences that include variability such as when errors are introduced into the data. Some embodiments are directed to techniques for accounting for such variability in input sequences processed by the system. For example, rather than considering the contribution of all input sources, some embodiments relate to a back-off technique that selectively disregards one or more input (evidence) sources to account for added or omitted items in an input sequence. In the examples that follow the macs are mandated to operate in retrieval mode. That is, regardless of which version of G it ultimately uses (i.e., “backs off to”), the system attempts to activate the code of the most closely matching stored sequence. In one envisioned usage, the back-off technique described herein operates only when the machine is in the overall mandated retrieval mode.

Some embodiments relate to methods and apparatus for considering different combinations of evidence sources to activate the codes of hypotheses that are most consistent with the total evidence input over the course of a sequence and with respect to learned statistics of an input space. Such embodiments introduce a general nonlinear time warp invariance capability in a sequence recognition system by evaluating a sequence of progressively lower-order estimates of a similarity distribution over the codes stored in a Sparsey mac. An “order” of an estimate refers to the number of evidence sources (factors) used in computing that estimate. Determining whether to analyze next lower-order estimates may be dependent upon the relation of a function of the estimates at a higher order to prescribed thresholds. In some embodiments, as lower-order estimates are evaluated, the thresholds may be increased to at least partially mitigate the risk of overgeneralization. More generally, the threshold used may be specific to the set of evidence sources used in producing the estimate.

Other embodiments relate to a multiple competing hypotheses (MCH)-handling technique that allows: a) multiple approximately equally likely hypotheses to be co-active in a mac for one or more time steps of a sequence; and b) selecting a subset (possibly of size one) of those multiple hypotheses to remain active after input of further disambiguating evidence to the mac. One or more steps of the CSA may be modified or added to implement the techniques described herein for tolerating input sequence variability.

Some embodiments relate to a process for choosing between equally (or nearly equally) plausible competing hypotheses in a sequence recognition system. Such embodiments use information from time-sequential items in the sequence to bias the selection of one of the competing hypotheses. For example, strengths of some signals emanating from a given mac, i.e., a “source” mac, may be selectively increased based on conditions in the source mac, e.g., on the number of competing hypotheses, ζ, that are approximately co-active in the source mac, to increase the accuracy of hypotheses activated in one or more “target” macs, where accuracy is measured relative to a parametrically prescribable statistical models of the hypothesis spaces of such target macs, and where the source mac may also be the target mac, i.e., as in a recurrent network.

The backoff method has several novel aspects. A) It is the first description of a method that, for each item of a sequence being processed, generates a series of estimates of the familiarity (likelihood) distribution over stored sequences, where the first estimate of the series is the most stringent, and subsequent estimates are progressively less stringent, and where the decision of which estimate to use is based on whether the estimates exceed familiarity thresholds, and where the number of computational steps needed to compute each estimate, which is a distribution over all stored sequences, does not depend on the number of stored sequences. B) It is the first description of the pairing of any type of back-off method with a computer memory that represents information using a sparse distributed representation (SDR) format, where, in particular, no method of dynamic time warping (DTW) (Sakoe and Chiba 1978) has previously been cast in an SDR framework, and no method of Katz's back-off method (Katz 1987), used in statistical language processing, has previously been cast in an SDR framework. Furthermore, the back-off method described herein is not equivalent to either DTW or Katz-type back-off.

The MCH-handling method also has several novel aspects. However, to begin with we point out that the pure idea that multiple hypotheses can be simultaneously active in a single active code is not novel, cf. (Pouget, Dayan et al. 2000, Pouget, Dayan et al. 2003, Jazayeri and Movshon 2006). In fact, the idea that multiple hypotheses can be simultaneously active in a single active SDR code was described in (Rinkus 2012). What is specifically novel about the MCH-handling method described here is as follows. A) it provides a way whereby multiple simultaneously active hypotheses in an SDR, each of which represented by only a fraction of its coding units being physically active, can nevertheless act with full strength (influence) in downstream computations, e.g., on the next time step. This allows the ongoing state of the SDR coding field to traverse ambiguous items of an input sequence, and recover to the correct likelihood estimate when and as disambiguating information arrives. B) It is the first description of a method to handle MCHs in and computer memory that used an SDR format.

In particular, our claim that neither the back-off method described herein (nor any type of back-off method described in the sequence recognition related literatures), nor the MCH-handling method have been described in the context of SDR-based models applies to all SDR-based described in the literature, including (Kanerva 1988, Moll, Miikkulainen et al. 1993, Rinkus 1996, Moll and Miikkulainen 1997, Rachkovskij 2001, Hecht-Nielsen 2005, Hecht-Nielsen 2005, Feldman and Valiant 2009, Kanerva 2009, Rinkus 2010, Snaider and Franklin 2011, Snaider 2012, Snaider and Franklin 2012, Snaider and Franklin 2012, De Sousa Webber 2014, Rinkus 2014, Snaider and Franklin 2014, Ahmad and hawkins 2015, Cui, Surpur et al. 2015, Hawkins, Ronald et al. 2016, Hawkins, Surpur et al. 2016).

The foregoing summary is provided by way of illustration and is not intended to be limiting.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 schematically illustrates a sparse distributed representation for a mac used in Sparsey;

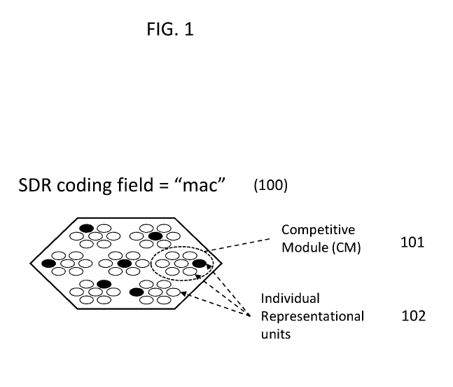

FIG. 2 schematically illustrates a hierarchical network of macs that may be used in accordance with some embodiments;

FIG. 3 shows the temporal and associative relations that exist amongst codes in macs at multiple levels during an example learning sequence (FIG. 3A) and during exact (FIG. 3B) and time-warped (FIG. 3C,D) test instances of that learning sequence;

FIG. 4 shows a flowchart of a back-off technique that may be used in accordance with some embodiments;

FIG. 5 schematically illustrates the formation of a spatiotemporal memory trace of an input sequence that may be used in accordance with some embodiments;

FIGS. 6A and 6B schematically illustrates motivation for using a back-off technique in accordance with some embodiments;

FIGS. 7A and 7B schematically illustrate complete test trial traces for training trials in which a back-off technique is not used, and when a back-off technique is used, respective, in accordance with some embodiments;

FIG. 8 schematically shows how increasing code intersection represents similarity in accordance with some embodiments;

FIGS. 9A and 9B schematically illustrate example input patterns and corresponding SDR codes that may be used in accordance with some embodiments;

FIG. 10 schematically illustrates a recurrent matrix that may be used in accordance with some embodiments;

FIG. 11 schematically illustrates the use of a recurrent matrix with multiple items over time in accordance with some embodiments; and

FIG. 12 schematically illustrates an MCH handling technique in accordance with some embodiments in which some inputs are associated with weights having strengths which are boosted based on the analysis of subsequent items in a sequence.

### DETAILED DESCRIPTION

The inventor has recognized and appreciated that in general, instances of sequences, either of particular individual sequences or of particular classes of sequences, which are produced by natural sources vary from one instance to another. Thus, there is the general need in sequence recognition system for some degree of tolerance to such variability. For example, some sequences may vary in speed and more generally, in the schedule of speeds, at which they progress. Some embodiments, described in more detail below, are directed to techniques for implementing a general nonlinear time warp invariance capability in Sparsey to tolerate such speed variances.

Sensors that provide sequential inputs to electronic systems typically have a sampling rate, i.e., the number of discrete measurements taken per unit time. This entails that for any particular sampling rate, a transient slowing down in the raw (analog) sensory input stream, X, with respect to some baseline speed may lead to duplicated measurements (items) in the resulting discrete time sequence with respect to the discrete time sequence resulting from the baseline speed instance. For present purposes, let the “baseline speed” of X be the speed at which X was first presented to the system, i.e., a “learning trial” of X. Thus, transient slow-down of a new “test trial” of X can lead to “insertions” of items into the resulting discrete sequence with respect to the training trial. Similarly, transient speed-ups of a test trial of X with respect to the learning trial of X can lead to whole items of the resulting discrete sequence being dropped (“deletions”). Thus, in many instances, the ability to detect non-linear time-warping of sequences reduces to the ability to detect insertions and deletions in discrete-time sequences.

For example, if a sequence recognition system has learned the sequence S1=[BOUNDARY] in the past and is now presented with S2=[BOUNDRY], should it decide that S2 is functionally equivalent to S1? That is, should it respond equivalently to S2 and S1? More precisely, should its internal state at the end of processing S2 be the same as it was at the end of processing S1? Many people would say yes, as spelling errors like this are frequently encountered and dismissed as typographical errors. Similarly, if one encountered S3=[BBOUNDARY], S4=[BBOOUUNNDDAARRYY], S5=[BOUNNNNNNDARY], or any of numerous other variations, one would likely decide it was an instance of S1. Variations (corruptions) such as these may be regarded simply as omissions/repetitions. However, as indicated above, they can be viewed as instances of the general class of nonlinearly time-warped instances of (discrete) sequences. Thus, S2 can be thought of as an instance of S1 that is presented at the same speed as during learning up until item “D” is reached, at which time the process presenting the items momentarily speeds up (e.g., doubles its speed) so that “A” is presented but is then replaced by “R” before the model's next sampling period to account for the omission of “A.” Then the process slows back down to its original speed and item “Y” is sampled. Thus S2 may be considered to be a nonlinearly time-warped instance of S1. Similar explanations may be constructed involving the underlying process producing the sequences undergoing a schedule of speedups and slowdowns relative to the original learning speed, e.g., for the examples of S3, S4, S5, discussed above. For example, S4 may be represented as a uniform slowing down, to half speed, of the entire process to account for the same letter being sampled twice in sequence.

In practice, there may be limits to how much the system should generalize regarding these warpings. The final equivalence classes, in particular for processing language, should be experience-dependent and idiosyncratic and may require supervised learning. For example, should a model interpret S6=[COD] as an instance of S7=[CLOUDS], produced twice as fast as during the learning instance? In general, the answer is probably no. Furthermore, the fact that the individual sequence items may actually be pixel patterns which can themselves by noisy, partially occluded, etc., has not been considered. Such factors are also likely to influence the normative category decisions. Nevertheless, the ubiquity of instances such as described above, not just in the realm of language, but in lower-level raw sensory inputs, suggests that a system have some technique for treating “moments”, i.e., particular items at particular positions in particular sequences, produced by nonlinearly time-warping as equivalent.

Some instances of DBMTS are called “complex sequence” domains (CSD), in which spatial input patterns, i.e., sequence items, can occur multiple times, in multiple sequential contexts, and in multiple sequences from the domain. Any natural language, e.g., English, text corpus constitutes a good example of a CSD. In processing complex sequences it is generally useful to be able to tolerate errors, e.g., mistakenly missing or inserted items. Some embodiments, described in more detail below, are directed to techniques for improving Sparsey's ability to tolerate such errors.

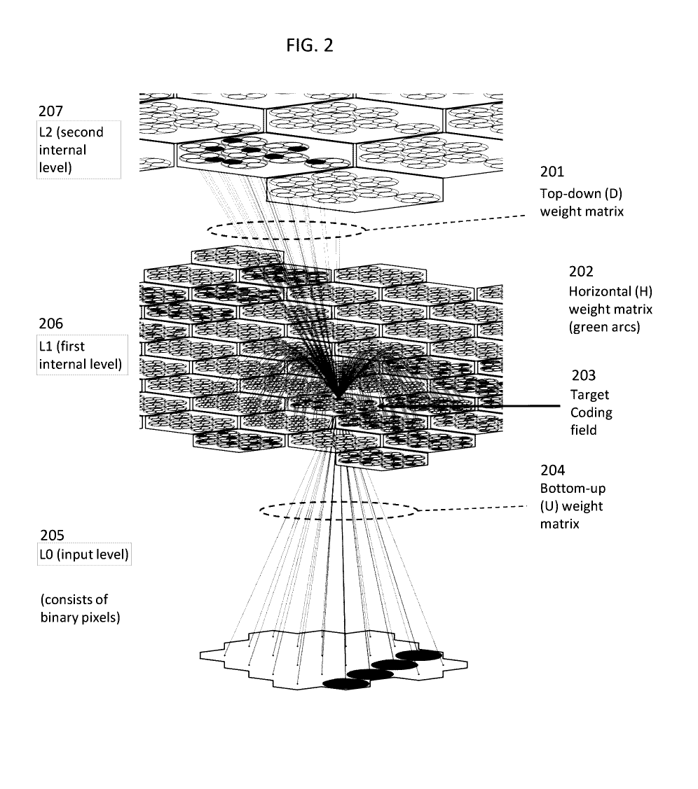

An important property of Sparsey is that the activation duration, or “persistence,” in terms of a number of sequence items, of codes increases with level. For example, the code duration for macs at the middle level 206 of FIG. 2 are defined to persist for one input item and the duration for codes at the top level 207 persist for two items. In some embodiments, the persistence may double with each higher level added. This architectural principle is called “progressive persistence.” In conjunction with the learning law described above, progressive persistence allows that in general, codes that become active at level J+1 may become “associatively linked” to multiple sequentially-active codes at level J.

Let a level J+1 mac, M^{α}, be active on two consecutive time steps, T and T+1. Let the persistence of level J+1=2, so that the same code, φ_{T}^{α}, is active at T and T+1 i.e., φ_{T}^{α}=α_{T+1}^{α}. In this case, M^{α} will become associated with codes in all level J macs, Mᵢ^{(J)}, with which it is physically connected, which are active on T+1 or T+2.

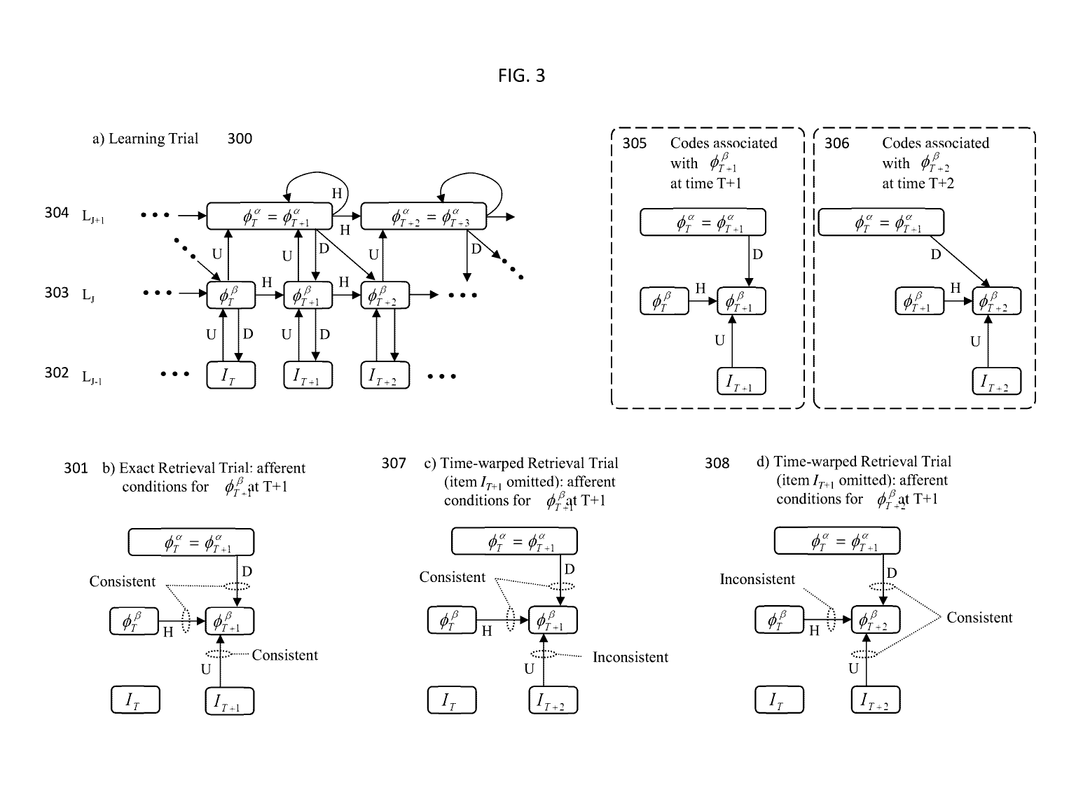

As a special case of the above, let M^{β} be one particular level J mac receiving D connections from M^{α} and let M^{β} be active at T+1 and T+2. And let the code active in M^{β} at T, φ_{T+1}^{β}, be different from that code active at T+1, φ_{T+2}^{β}. Suppose these conditions occurred while the model was in learning mode, so that φ_{T}^{α} became associatively linked to both φ_{T+1}^{β}, and φ_{T+2}^{β}. FIG. 3A (300) illustrates this situation. It shows a time sequence of codes that become active in M^{α} (top row, L_{J+1}) and M^{β} (middle row, L_{J}) during time steps T to T+2. The black arrows show the U, H, and D, associations that would be made during the learning trial. Note that the rounded rectangles are roughly twice as wide at L_{J+1} indicating that these codes last (persist) twice as long as those at L_{J}. Also note that since L_{J+1} codes persist for two time steps and since M^{α}'s H-matrix is recurrent, any code that becomes active in M^{α} both autoassociates with itself (indicated by the recurrent arrows at L_{J+1} 304 of FIG. 3) and heteroassociates with the next code active in M^{α} (if there is a next active code).

The insets 305 and 306 show the total inputs to M^{β} at T+1 and T+2, respectively, of the learning trial. Thus, at T+1, the weight increases to φ_{T+1}^{β}, will be from units in the set of codes {φ_{T}^{α}, φ_{T}^{β}, I_{T+1}} where the last code listed, I_{T+1}, is not an SDR code, but rather is an input pattern consisting of some number of active features, e.g., pixels. At T+2, the weight increases to φ_{T+2}^{β} will be from units in the set of codes {φ_{T}^{α}, φ_{T+1}^{β}, I_{T+2}}. This learning means that on future occasions (e.g., during future test trials), if φ_{T}^{α} becomes active in M^{α} (for any reason), its D-signals to M^{β} will be equally and fully consistent with both φ_{T+1}^{β} and φ_{T+2}^{β}. Note that in general, due to learning that may have occurred on other occasions when φ_{T}^{α} was active in M^{α} and other codes active in M^{β}, φ_{T}^{α} may be equally and fully consistent with additional codes stored in M^{β}. However, for present purposes it is sufficient to consider only that φ_{T}^{α} has become associated with φ_{T}^{β} and φ_{T+1}^{β}.

On a particular time step of a retrieval trial, the condition in which D-signals to M^{β} are equally and fully consistent with both φ_{T+1}^{β} and φ_{T+2}^{β} is manifest in the D-vector (produced in CSA Step 3) over the units comprising M^{β}. Specifically, in the D-vector over the K units comprising each individual CM, q, D will equal 1.0 for the unit in q that is contained in φ_{T+1}^{β} and for the unit in q that is contained in φ_{T+2}^{β}. In some embodiments, during learning, a time-dependent decrease in the strength of D-learning that takes place from an active code at one level onto successively active codes in target macs in the subjacent level, may be imposed. Specifically, the decrease may be a function of difference in the start times of the involved source and target codes. This provides a further source of information to assist during retrieval.

FIG. 3B (301) shows that if the same sequence (with the same timing) is presented on a retrieval trial, the total input to M^{β} will be the same as it was on the learning trial, i.e., the set of active afferent codes to M^{β} will be {φ_{T}^{α}, φ_{T}^{β}, I_{T+1}}. Accordingly, Sparsey's method of combining all three inputs (factors) multiplicatively in computing G, will yield G=1. By the additional steps of the CSA, this will maximize the probability of activating the whole code, φ_{T+1}^{β}, i.e., of choosing, in each of M^{β}'s Q CMs, the unit that is contained in φ_{T+1}^{β}. In such a case, back-off would not be needed to recognize a test sequence that is identical to a training sequence.

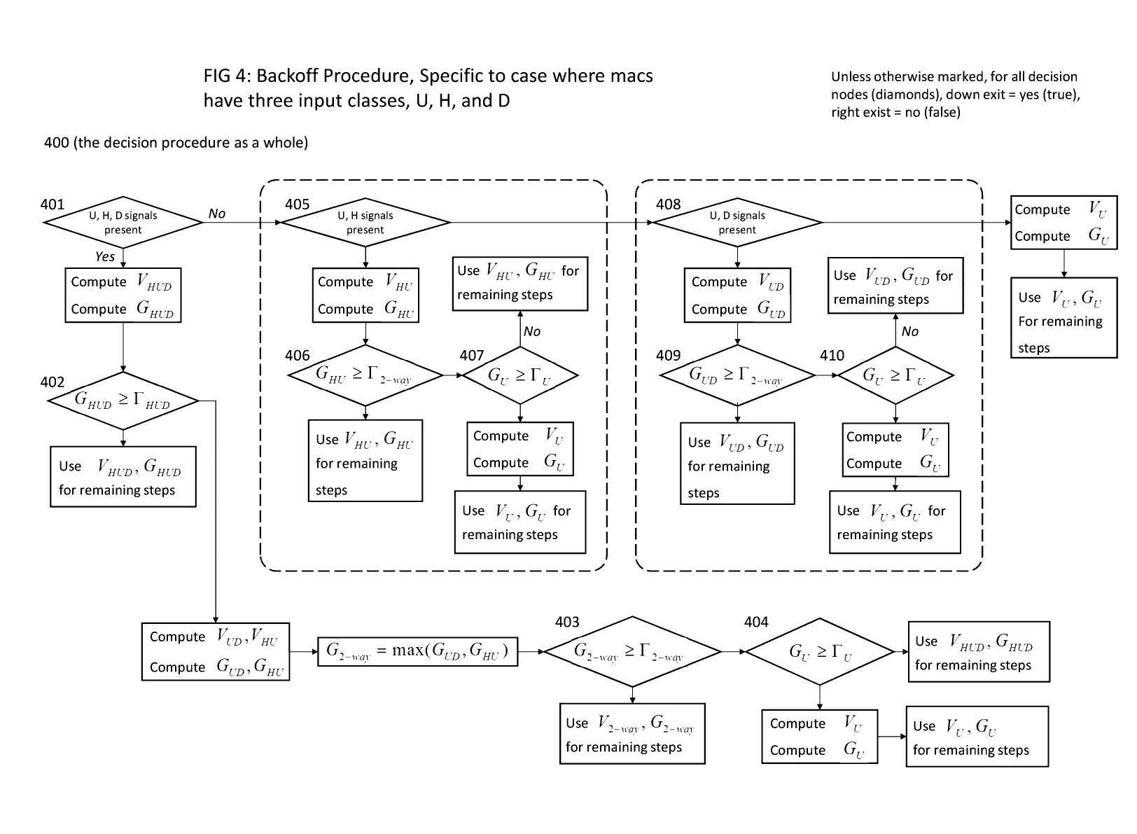

FIG. 3C (307) shows the total input conditions to M^{β} at T+1 of retrieval trial of a time-warped instance of this learning trial sequence, with respect to the code, φ_{T+1}^{β}. FIG. 4D (308) shows these input conditions with respect to the code, φ_{T+2}^{β}. Specifically, in the test sequence, the original (T+1)^{th} item, I_{T+1}, is omitted, so that the original (T+2)^{th} item, I_{T+2}, is presented as the (T+1)^{th} item. In this case, the total input to M^{β} is {φ_{T}^{α}, φ_{T}^{β}, I_{T+2}}. As indicated in the figure, with respect to φ_{T+1}^{β}, the U signals are not consistent with H and D signals, and with respect to φ_{T+2}^{β}, the H signals are not consistent with the U and D signals. If Sparsey follows its original logic and simply multiplies the three factors, U, H, and D, this would generally yield a low G, possibly G=0. A value of G computed using all three of these factors is denoted as G_{HUD}. In this case, the additional steps of the CSA, would not maximize the probability of activating the whole code, φ_{T+1}^{β}. In fact, as G decreases toward zero, the expected intersection of the code that is activated with φ_{T+1}^{β} approaches chance. Thus, with high likelihood, neither φ_{T+1}^{β} nor φ_{T+2}^{β} will be wholly reinstated. Yet, as discussed above, there are natural sequential input domains for which whole insertions and deletions in retrieval test trials may occur significantly often. Thus, it is desirable to have a mechanism whereby the mac could recognize that the current input, I_{T+2}, is occurring within a reasonable temporal proximity to its original temporal position (relative to its encompassing sequence) and thus reinstate the whole code, φ_{T+2}^{β} at time T+1 of the test sequence. Thus, the mac acts to “catch up to” currently unfolding sequence, which has, at least momentarily, sped up with respect to its original learning speed. Note that if, in this scenario, φ_{T+2}^{β} were to be reinstated, then the entire state of the system, i.e., the codes active at all three levels would be in the correct state to receive the next input that occurred in the original learning sequence [as suggested by ellipsis dots in FIG. 3A (300)].

FIG. 3D (308) suggests a solution in accordance with some embodiments. If the inconsistent H signals are ignored in computing G, then a G value of 1.0 may still be attainable. Let the version of G computed by multiplying only the two factors, U and D, be denoted G_{UD}. Since the 3-way version, G_{HUD}, involves three factors, G_{HUD} is referred to as a 3^{rd}-order measure (of similarity, or likelihood). Similarly, G_{UD} is a 2^{nd}-order measure. The process of first considering using the highest-order measure available, in this case, G_{HUD}, but rejecting it based on some criterion and moving on to progressively lower order measures, in this case, G_{UD}, is referred to herein as “backing off” and to the associated technique as a “back-off technique”. In this example, backing off to G_{UD} allows the subsequent steps of the CSA to, with high likelihood, reinstate φ_{T+2}^{β}, in its entirety. In this example as discussed so far, the criterion for rejecting G_{HUD} is that it would yield a low G value. A low G value would likely result in a novel code being activated in M^{β}, which indicates that M^{β} does not recognize the current sequence as an instance of any known (stored) sequence. The actual criterion is attainment of a threshold, Γ_{HUD}, as described below and shown in FIG. 4.

It is also true that FIG. 3C (307) suggests a different solution, i.e., that the inconsistent U signals be ignored. In this case, the mac would back-off from G_{HUD} to G_{HD}, which would also yield a high G value. In this case, the high G in conjunction with the H and D signals would, with high likelihood, reinstate the code φ_{T+1}^{β} in its entirety. While the option to back off to a version of G such as G_{HD}, which ignores the mac's U input and thus ignores the actual input (possibly filtered via lower levels) from the world at the current time, may be useful in some scenarios and applications, it seems plausible that given the choice between a version of G that does include the U inputs and one that does not, the former should be preferred. In some embodiments, versions of G which do not include the U inputs may not be considered during back-off. In fact, this is the case for the particular instance of the back-off procedure shown in FIG. 4 (described below).

The example of FIG. 3 illustrates a case in which backing off only once, i.e., from the highest order G available to the next highest, suffices to recover a G value that may be close to 1 with high likelihood. However, in general, the same logic may be recursively applied. For example, G_{UD} might also be rejected on the basis of some criterion, in which case the mac can compute G based only on the U inputs. i.e., G_{U}. In this case, basing G, and therefore the choice of which code to activate, only on the U signals, essentially ignores all temporal context signals to the mac. More generally, the back-off technique may be viewed as considering a succession of estimates of the similarities (likelihoods) of the current input sequence, i.e., the current sequence up to and including the current item, based on progressively weaker temporal context constraints. Some embodiments are directed to a systematic method for considering different combinations of evidence sources to activate the codes of hypotheses that are most consistent with the total evidence input over the course of a sequence and with respect to learned statistics of the input space. “Learned statistics” are statistics of the sequences presented to the mac during a prior learning phase. These statistics include the detailed knowledge (memory) of the individual presented sequences themselves.

G has been described as having an order equal to the number of factors used to compute it. In fact, G is an average of V values and it is the V value, of an individual unit, which is directly computed as a product, as in CSA Step 4. In early versions of Sparsey, the number of factors (Z) used in V was always equal to the number of active evidence sources. The inventor has recognized and appreciated that the ability of Sparsey to recognize time-warped instances of known (stored) sequences may be improved with the inclusion of a technique by which a sequence of progressively lower-order products in which one or more of the factors are omitted (ignored) is considered. Some embodiments are directed to a technique for evaluating a sequence of progressively lower-order V estimates of the similarity distribution of a Sparsey mac, dependent upon the relation of a function of those estimates to prescribed thresholds. Specifically, the function, G, is the average of the maximum V values across the Q CMs comprising the mac (CSA Step 8).

Accordingly, some embodiments are directed to an elaboration and improvement of CSA Steps 4 and 8 by computing multiple versions of V (e.g., of multiple orders and/or multiple versions within individual orders) and their corresponding versions of G. For each version of V a corresponding version of G is computed.

The general concept of a back-off technique in accordance with some embodiments is as follows. If the input domain is likely to produce time-warped instances of known sequences with non-negligible frequency, then the system should routinely test whether the sequence currently being input is a time-warped instance of a known sequence. That is, it should test to see if the current input item of the sequence currently being presented may have occurred at approximately the same sequential position in prior instances of the sequence. In one embodiment, every mac in a Sparsey machine executes this test on every time step on which it is active.

FIG. 4 shows an instance of a back-off technique in accordance with some embodiments. This technique applies to macs that have up to three active inputs classes, U, H, and D. Initially, the procedure is described for a mac that has three input sources, and for which on the current time step of a sequence, it is receiving signals from all three sources. Thus, the first decision step 401 exits via the “yes” branch. The mac will compute V_{HUD} for every one of its units. Recall, the mac consists of Q CMs each with K units; therefore the V vector is of size Q×K. Once the V vector, specifically the V_{HUD} vector, is computed, the mac executes CSA Steps 7 and 8, resulting in G_{HUD}. It then compares 402 G_{HUD} to a threshold, Γ_{HUD}. If it attains the threshold, then the remainder of the steps of the algorithm executed on the current time step will use the computed values of V and G, namely, V_{HUD} and G_{HUD}.

However, if it fails this test 402, it considers one or more 2^{nd} order G versions. As noted earlier, the H and D signals carry temporal context information about the current sequence item being input, i.e., about the history of items leading up to the current item. The U inputs carry only the information about that current item. If G includes the H and D signals, it can be viewed as a measure of how well the current item matches the temporal context. Thus, testing to see if the current input may have occurred at approximately the same position in the current context on some prior occasion can be achieved by omitting one or both of the H and D signals from the match calculation. There are three possible 2-way matches, G_{UD}, G_{HU}, and G_{HD}. However, as noted above, in the depicted instance of the back-off technique, only G measures that include U signals are considered. Thus, the mac computes G_{UD} and G_{HU}. It first takes their max, denoted as G_{2-way}, and compares 403 it to another threshold, Γ_{2-way}. Backing off to either G_{UD} or G_{HU} increases the space of possible current inputs that would yield G=1, i.e. the space of possible current inputs that would be recognized, i.e., equated with a known sequence, X. In other words, it admits a larger space of possible context-input pairings to the class that would attain a G=1 (more generally, to the class attaining any prescribed value of G, e.g., Γ_{2-way}). Backing off therefore constitutes using an easier test of whether or not the current input is an instance of X. Because it is an easier test, in some embodiments, a higher score is demanded if the result of the test is going to be used (e.g., to base a decision on). Accordingly, in some embodiments, Γ_{2-way}>Γ_{HUD}. A general statistical principle is that the score attained on a test trades off against the degree of difficulty of the test. To base a decision on the outcome of a test, a higher score for an easier test may be demanded. If it attains the threshold, then the remainder of the steps of the algorithm executed on the current time step will use the computed values of V and G, namely, V_{2-way} and G_{2-way}.

However, if it fails this test 403, the next lowest-order versions of G available may be considered. In some embodiments, these may include G_{H} and G_{D} but in the example, only G_{U} is considered. G_{U} is compared 404 against another threshold, Γ_{U}. If the threshold is attained, the remainder of the steps of the algorithm executed on the current time step will use the computed values of V and G, namely, V_{U} and G_{U}. This further increases the space of possible context-input pairings that would attain any prescribed threshold. In fact, if backed off to G_{U}, then if the current input item has ever occurred at any position of any previously encountered sequence, then the current input sequence will be recognized as an instance of that sequence. More generally, if the current input item has occurred multiple times, the mac will enter a state that is a superposition of hypotheses corresponding to all such context-input pairings, i.e., all such sequences.

The remaining parts of FIG. 4 consider the cases where the mac has fewer active input classes, but the back-off logic within those branches is essentially similar. In some embodiments thresholds may be specific to branch. In some embodiments, if all lower-order versions of G tested fail their thresholds, the mac reverts to using the highest-order G available.

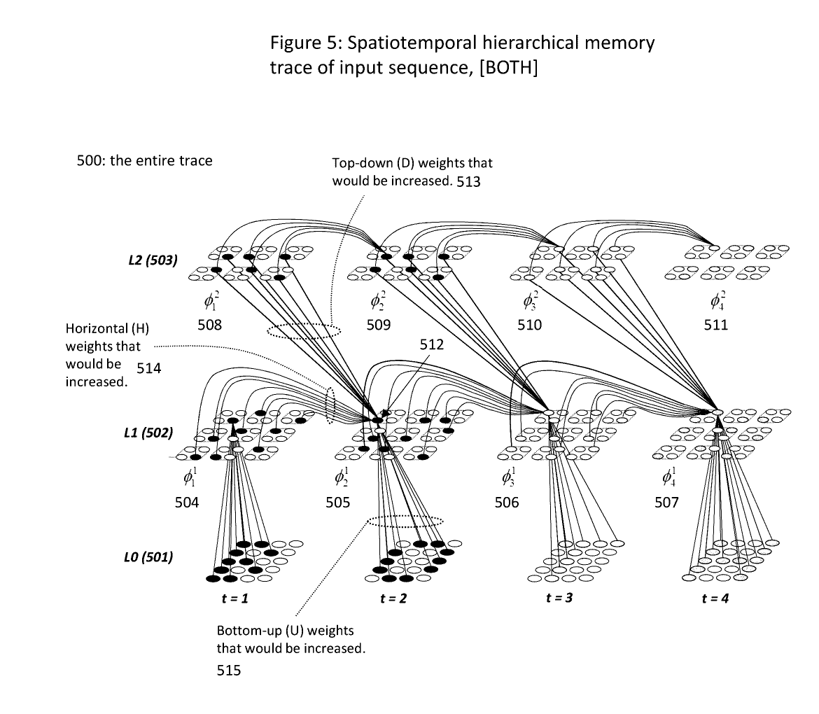

To illustrate aspects of some embodiments, FIG. 5 shows an example involving a 3-level model that has only one mac at each internal level. However, it should be appreciated that more or less complex models having any number of macs at each level may be used. Only representative samples of the increased weights on each frame are shown in FIG. 5. The model has one L1 mac with Q₁=9 CMs, each with K₁=4 cells and one L2 mac with Q₂=6 CMs, each with K₂=4 cells. The resulting trace can be said to have been produced using both chaining (increasing H-wts between successively active codes at the same level) and chunking (increasing U and D wts between single higher-level (L2) codes and multiple lower-level (L1) codes. The example in FIGS. 5-7 is closely analogous to that of FIG. 3, except that it exposes the underlying SDR nature of the codes and the processes involved.

FIG. 5 shows representative samples of the U, H, and D learning (515, 514, and 513, respectively) that would have occurred on a learning trial as the model was presented with the sequence, [BOTH]. Note that the model is unrolled in time, i.e., the model is pictured at four successive time steps (t1-t4) and in particular, the origin and destination cell populations of the increased H synapses (green) are the same. FIG. 5 shows this representative learning for one cell—the winner in the upper left CM of the L1 mac—at each time step, emphasizing that, on each moment, individual cells become associated with their total afferent input (spatiotemporal context) in one fell swoop (as has also been described earlier with respect to FIG. 3). Though this is only shown as occurring for one cell on each frame, all winners in a mac code receive the same weight increases simultaneously. Thus not only do individual cells become associated with the mac's entire spatiotemporal contexts, but entire mac codes become associated with the mac's entire spatiotemporal contexts.

The first L2 code that becomes active D-associates with two L1 codes, φ₂¹ 505 and φ₃¹ 506. The second L2 code to become active, φ₃² 510 (orange), D-associates with φ₄¹ 507 and would associate with a t=5 L1 code if one occurred.

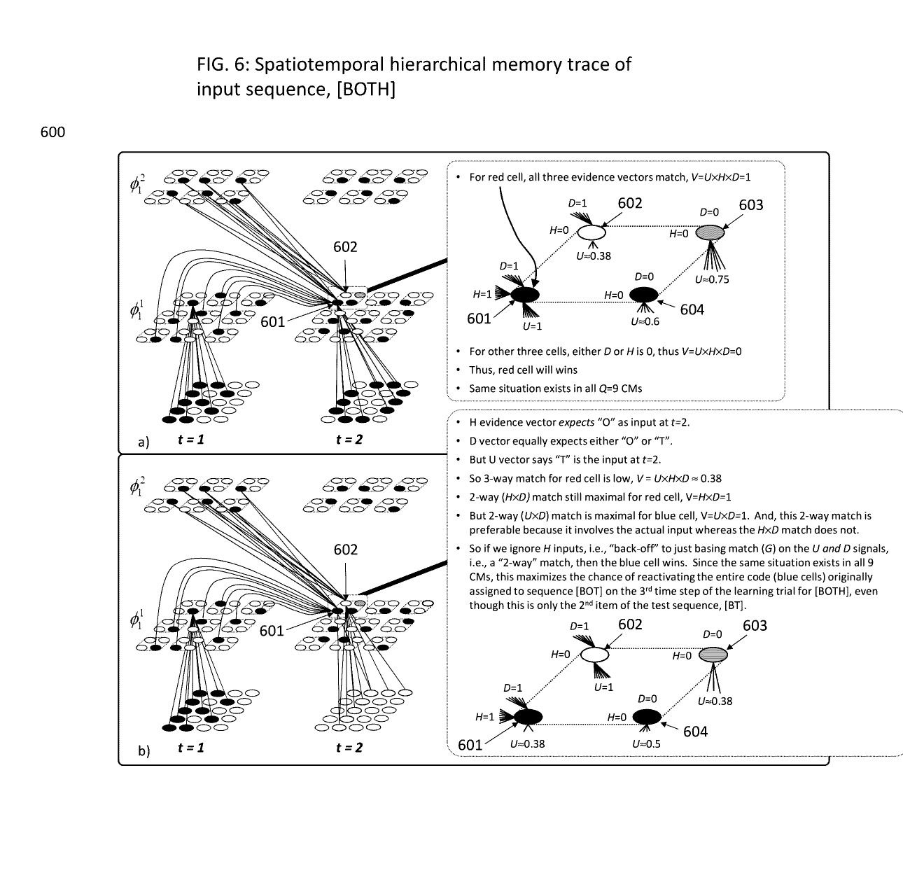

Having illustrated (in FIG. 5) the nature of the hierarchical spatiotemporal memory trace that the model forms for [BOTH], FIG. 6 compares model conditions when processing one particular moment—the second moment—of a test trial that is identical to the learning trial (FIG. 6A) to conditions when processing the second moment of a time-warped instance of the learning trial—specifically, a moment at which the item that originally appeared as the third item of the learning trial, “T”, now appears as the second item immediately after “B”, i.e., “O” in [BOTH] has been omitted (FIG. 6B). The two test trial moments are represented as [BO] and [BT], respectively, where bolding indicates the frame currently being processed and the non-bolded letters indicate the context (prefix of items) leading up to the current moment. The second moment of the time-warped instance is simply a novel moment. Thus, the caveat mentioned above applies. That is, deciding whether a particular novel input moment should be considered a time-warped instance of a known moment or as a new moment altogether may not be done absolutely.

FIG. 6A shows the case where the test trial moment [BO] is identical to the learning trial moment [BO]. It should be observed that, given the weight increases that will have occurred on the learning trial, all three input vectors, U, H, and D, will be maximal (equal to 1) for the red cell 601 (which is in φ₂¹). Similarly, in each of the nine L1 CMs, there will be a cell, namely the cell that was in φ₂¹, for which all three input vectors will equal 1. Pictured on the right (light gray inset), only the conditions for the upper left L1 CM are shown, but the conditions are statistically similar for all L1 CMs. For the red cell 601, U=1, H=1, and D=1. The blue cell 602 (which is in φ₃¹) also has maximal D-support. The blue 602, green 603, and black 604 cells have non-zero U inputs (their U-inputs are not shown on the left side of FIG. 6A to minimize clutter), due to the pixel overlap amongst the four input patterns, but they all have H=0. Thus, according to CSA Step 4 (Table 1), the red 601 cell has V=U×H×D=1, whereas the others have V=U×H×D=0. Since the same conditions exist in each of the nine CMs—i.e., there is a red cell with V=U×H×D=1, then CSA Steps 7 and 8 yield G_{HUD}=1, which will, via the rest of the CSA's steps, result in activation of the entire code, φ₂¹ with very high likelihood. Thus, in this case, where the test moment is identical to a learned moment, CSA Eq. 4 is sufficient without modification.

However as shown in FIG. 6B, when an item (“O”) has been omitted with respect to the learning trial, the H and D vectors to the red cell 601 will no longer agree with its U vector. In this particular case, G_{HUD}=0.38, which would fail a typical threshold of Γ_{HUD}=0.9 (402). In accordance with the embodiment shown in FIG. 4, the mac checks whether the current moment could have resulted from a time-warping process by computing the 2^{nd} order G's. In this case, G_{UD}=1 which would attain any 2-way threshold that could be used (since they all must be in [0.0,1.0]), in particular, Γ_{2-way}=0.93 (403). Thus, the mac uses G_{UD} and G_{UD} for the rest of the CSA's steps, which would result, with high likelihood, in reactivation of φ₃¹.

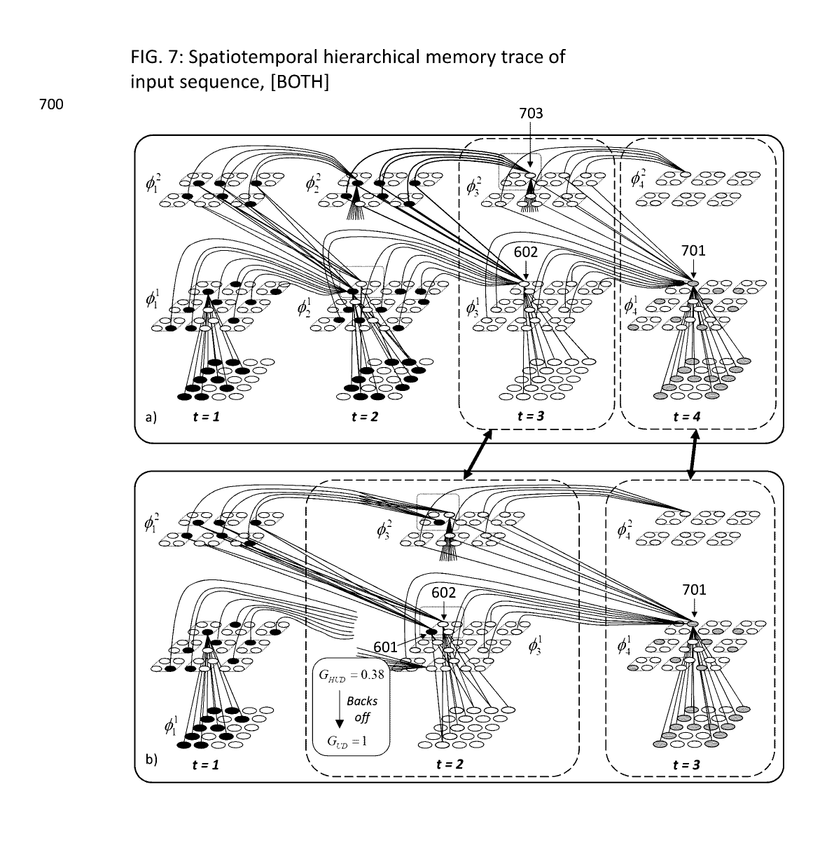

FIG. 7 further elaborates on FIG. 6, to show how the back-off technique employed in accordance with some embodiments allows the mac to keep pace with nonlinearly time-warped instances of previously learned sequences. That is, the mac's internal state (i.e., the codes active in the macs) can either advance more quickly (as in this example) or slow down to stay in sync with the sequence being presented. FIG. 7A shows the full memory trace that becomes active during a retrieval trial for an exact duplicate of the training trial, [BOTH]. In this case, no back-off would be employed because all signals at all times would be the same during retrieval as they were during learning.

FIG. 7B shows the trace obtained using the back-off technique, throughout presentation of the nonlinearly time-warped instance of the training trial, [BTH]. It emphasizes how the mac's internal state keeps pace with the time-warped input sequence, in particular, so that the signaling conditions for the item following the time step affected by the warping are the same as they were for the corresponding item on the associated learning trial. Thus, the U, H, and D, inputs to the units comprising the code, φ₄¹ (for the input item “H”), are identical: this is illustrated for just one of those units 701.

The back-off from G_{HUD} to G_{UD} occurs in the L1 mac at time t=2 (as was described in FIG. 6B). Consequently, φ₃¹ (blue cells, one of which is indicated 602) is activated. Thus, the back-off has allowed the model's internal state in L1 to “catch up” to the momentarily sped up process that is producing the input sequence. Once φ₃¹ is activated, it sends U-signals to L2 (blue signals converging on orange cell in rose highlight box, 703). This results in the L2 code, φ₃² (orange cells), being activated without requiring any back-off because the L2 code from which H signals arrive at t=2, φ₁² (purple cells) increased its weights not only onto itself (at t=2 of the learning trial) but also onto φ₃² at t=3 of the learning trial. Thus, the six cells comprising φ₃² (orange) yield G_{HU}=1 (note that G_{HU} is the highest order G version available at L2 since there is no higher level and therefore no D signals). Consequently, with high likelihood φ₃² is reactivated at t=2 of this test trial (FIG. 7B) even though φ₃² only became activated at time t=3 of the learning trial (FIG. 7A). At this point—time t=2 of the test trial—the entire internal state of the model, at L1 and L2, is identical to its state at time t=3 of the learning trial (two central dashed boxes connected by double-headed black arrow): the model, as a whole, has “caught up” with the momentary speed up of the sequence. The remainder of the sequence proceeds the same as it did during learning, i.e., the state at time t=3 of retrieval trial equals the state at time t=4 of learning trial.

In this example just described, G_{UD}=1, meaning that there is a code stored in the L1 mac—specifically, the set of blue cells assigned as the L1 code at time t=3 of the learning trial (FIG. 6)—which yields a perfect 2-way match. Thus, there is no need to back-off to the next lower level (“1-way” match) criterion, e.g., G_{U}. Any suitable precedence order of the different G versions and whether or not and under what conditions the various versions should be considered may be used in accordance with some embodiments, and the order used in the example discussed above is provided merely for illustrative purposes.

In accordance with some embodiments, the back-off technique described herein does not change the time complexity of the CSA: it still runs with fixed time complexity, which is important for scalability to real-world problems. Expanding the logic to compute multiple versions of G increases the absolute number of computer operations required by a single execution of the CSA. However, the number of possible G versions is small and fixed. Thus, modifying previous versions of Sparsey to include the back-off technique in accordance with some embodiments adds only a fixed number of operations to the CSA and so does not change the CSA's time complexity. In particular, and as further elaborated in the next paragraph, the number of computational steps needed to compare the current input moment, i.e., the current input item given the prefix of items leading up to it, not only to all stored sequences (i.e., all sequences that actually occurred during learning) but also all time-warped versions of stored sequences that are equivalent under the implemented back-off policy (with its specific parameters, e.g., threshold settings) to any stored sequence, remains constant for the life of the system, even as additional codes (sequences) are stored.

During each execution of the CSA, all stored codes compete with each other. In general, the set of stored codes will correspond to moments spanning a large range of Markov orders. For example, in FIG. 7B, the four moments, [B], [BO], [BOT], and [BOTH], are stored, which are of progressively greater Markov order. During each moment of retrieval, they all compete. More specifically, they all compete first using the highest-order G, and then if necessary, using progressively lower-order G's. However, with using the back-off technique described herein, not only are explicitly stored (i.e., actually experienced) moments compared, but so are many other time-warped versions of the actually-experienced moments, which themselves have not occurred. For example in FIGS. 6B and 7B, the moment [BT], which never actually occurred competes and wins (by virtue of back-off) over the moment [BO], which did occur. It should be appreciated that the above-described back-off technique and reasoning generalizes to arbitrarily deep hierarchies. As the number of levels increases, with persistence doubling at each level, the space of hypothetical nonlinearly time-warped versions of actually experienced moments, which will materially compete with the actual moments (on every frame and in every mac) grows exponentially. And, these exponentially increasing spaces of never-actually-experienced hypotheses are envelopes around the actually-experienced moments: thus, the invariances implicitly represented by these envelopes are (a) learned and (b) idiosyncratic to the specific experience of the model.

As discussed briefly above, some embodiments are directed to a technique that tolerates errors (e.g., missing or inserted items) in processing complex sequences (e.g., CSDs) using Sparsey. In this technique, referred to herein as the “multiple competing hypothesis (MCH) handling technique” or more simply the “MCH-handling technique,” the presence of multiple equally and maximally plausible hypotheses are detected at time T (i.e., on item T) of a sequence, and internal signaling in the model is modulated so when subsequently entered information, e.g., at T+1, favors a subset of those hypotheses, the machine's state is made consistent with that subset.

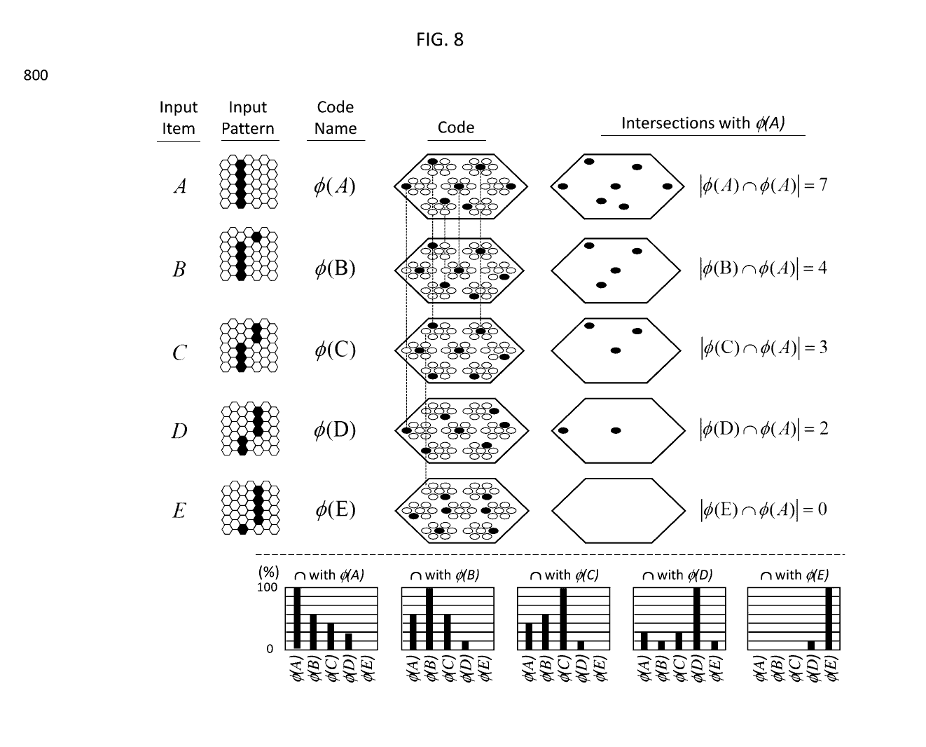

An important property of a Sparsey mac is its ability to simultaneously represent multiple hypotheses at various strengths of activation, i.e., at various likelihoods, or degrees of belief. The single code active in a mac at any given time represents the complete likelihood/belief distribution over all codes that have been stored in the mac. This concept is illustrated in FIG. 8. FIG. 8 shows a set of inputs, A to E, with decreasing similarity, where similarity is measured simply as pixel (more generally, binary feature) overlap. A hypothetical set of codes, φ(A) to φ(E) is assigned to represent each of the inputs A to E. FIG. 8 also shows the intersections (i.e., shared common cells) of each of the codes φ(A) to φ(E) with the code φ(A). As shown, the size of the intersection of the codes correlates directly with the similarity of the inputs. Although the hypothetical inputs, A to E, are described as purely spatial patterns in FIG. 8, the same principle, i.e., mapping similar inputs to more highly intersecting codes applies to the case where the inputs are sequences (i.e., spatiotemporal patterns).

As described above, the Sparsey method combines multiple sources of input using multiplication, where some of the input sources represent information about prior items in the sequence (and in fact, represent information about all prior items in the sequence up to and including the first item in the sequence), to select the code that becomes active. This implies and implements a particular spatiotemporal similarity measure having details that depend on the parameter details of the particular instantiation.

Given that a mac can represent multiple hypotheses at various levels of activation, one subclass of this condition is the subclass in which multiple of the stored hypotheses are equally (or nearly equally) active and where that level of activation is substantially higher than the level at which all other hypotheses stored in the mac are active. Furthermore, the MCH-handling technique described herein primarily addresses the case in which the number, ζ, of such high-likelihood competing hypotheses (HLCHs) is small, e.g., ζ=2, 3, etc., which is referred to herein as an “MCH condition.”

A mac that consists of Q CMs, can represent Q+1 levels of activation for any code, X, and can range in activation from 0% active, in which none of the code X's units are active to 100% active, in which all of code X's units are active. A hypothesis whose code has zero intersection with the currently active code is at activation level zero (i.e., inactive). A hypothesis whose code intersects completely, i.e., in all Q CMs, with the current code is fully (100%) active. A hypothesis whose code intersects with the currently active code in Q/2 of the CMs is 50% active, etc.

In an MCH condition in which ζ=2, each of the two competing codes, X and Y, could be 50% active, i.e., in Q/2 of the CMs, the unit that is contained in φ(X) is active and in the other Q/2 CMs, the unit contained in φ(Y) is active. However, since φ(X) and φ(Y) can have a non-null intersection (i.e., the same active cells are present in both codes), both of these codes (and thus, the hypotheses they represent) may be more than 50% active. Similarly, if ζ=3, each of the three HLCHs may be more than 33% active if there is some overlap between the active cells in the three codes.

In a subset of instances in which an MCH condition exists in a mac at time T of a sequence, subsequent information may be fully consistent with a subset (e.g., one or more) of those hypotheses and inconsistent with the rest. Some embodiments directed to an MCH-handling technique ensure that the code activated in mac accurately reflects the new information.

When processing complex sequences, e.g., strings of English text, it may not be known for certain whether the sequence as input thus far includes errors. For example, if the input string is [DOOG], it may reasonably be inferred that the letter “O” was mistakenly duplicated and that the string should have been [DOG]. However, the inclusion of the extra “O” might not be an error; it could be a proper noun, e.g., someone's name, etc. Neither the Sparsey class of machines nor MCH-handling techniques described herein purport to be able to detect errors in an absolute sense. Rather, error correction is always at least implicitly defined with respect to a statistical model of the domain.

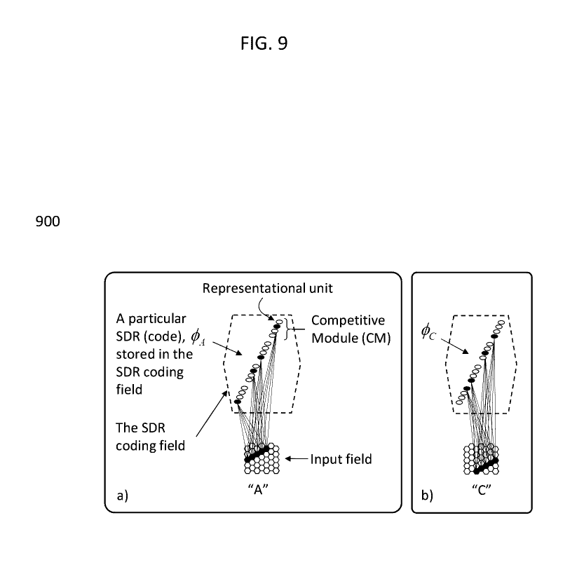

In the example used in this document, a very simple domain model is assumed. Specifically, the example discussed in accordance with FIGS. 9-12, it is assumed that only two sequences have been stored in the model [ABC] and [DBE]. Because “B” occurs multiple times, in multiple sequential contexts, and in fact in multiple sequences, this set constitutes a CSD. Given that particular knowledge base, it is reasonable that if subsequently, i.e., on a separate test trial, presented with “B” as the start of a sequence, the machine would enter an internal state in which it was expecting the next item to be either “C” or “E” with equal likelihood. It is also reasonable that once either of those two items arrives, that the machine would enter the same internal state it had at the end of processing the corresponding original sequence. For example, if the next item is “C”, then entering the state it had on the final (3^{rd}) item of the known sequence, [ABC], would be plausible. In the case of an SDR model such as Sparsey, “entering the same state” means that the same code is activated in the mac.

While the example described herein in connection with FIGS. 9-12, and in particular, the underlying assumed statistical domain model, is simple, embodiments are applicable to a much wider range of statistical domain models as aspects of the invention are not limited to use with simple models.

Early versions of the Sparsey model did not include a mechanism for explicitly modulating processing based on and in response to the existence of MCH conditions. The MCH-handling technique in accordance with some embodiments constitutes a mechanism for doing so. It is embodied in a modification to CSA Step 2, and the addition of two new steps, CSA Step 5 and Step 6.

FIG. 9A shows a simple example machine consisting of an input field (which does not use SDR), a single mac (dashed hexagon), and a bottom-up (U) matrix of weights that connects the input field to the mac. The input field is an array of binary features; we will refer to these features as pixels, though they can represent information from any sensory modality. The U matrix is complete, i.e., every input unit is connected to every unit in the mac. The weights may be binary or have an arbitrary number of discrete values. In the examples described herein it is assumed that the weights are binary. The mac used as an example in FIGS. 9-12 consists of Q groups, each group consisting of K binary units. Only one unit may be active in a group at any one time. Hence, these groups are said to function in “winner-take-all” (WTA) fashion, as described above.

FIG. 9 shows a 5×7 input array of binary features (pixels) connected via a weight matrix to an SDR. FIG. 9a shows an example input pattern, denoted “A”, which has been associated with an example code, φ_{A}. The example code φ_{A} is shown as including a set of four black circles (units). (Note that the input patterns used in FIGS. 9-12 are unrelated to those of FIG. 8.) That association is physically embodied as the set of increased binary weights shown (black lines). The act of associating an input with a code can also be referred to as “storing the input”. FIG. 9B shows another input “C” that has been stored, in this case, as the code, φ_{C}. Note that in this particular example, the two codes, φ_{A} and φ_{C}, do not intersect (i.e., do not share active cells in common), though in general, codes stored in an SDR mac can and often do intersect. This property—that the codes stored in an SDR mac can intersect—underlies the power of SDR and was illustrated and described in connection with FIG. 8.

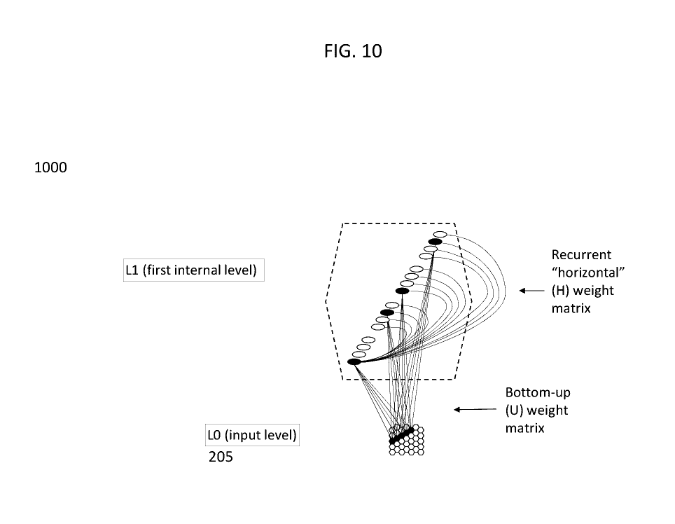

FIG. 10 augments the mac in FIG. 9 by adding a recurrent H matrix. The recurrent matrix connects the bottom-most unit of the mac to the 12 other units not in the source unit's own CM. Each of the 16 units would have a similar matrix connecting to the 12 units in the three CMs other than its own. The entire recurrent “horizontal” (H) matrix would then consist of 16×12=192 weights.

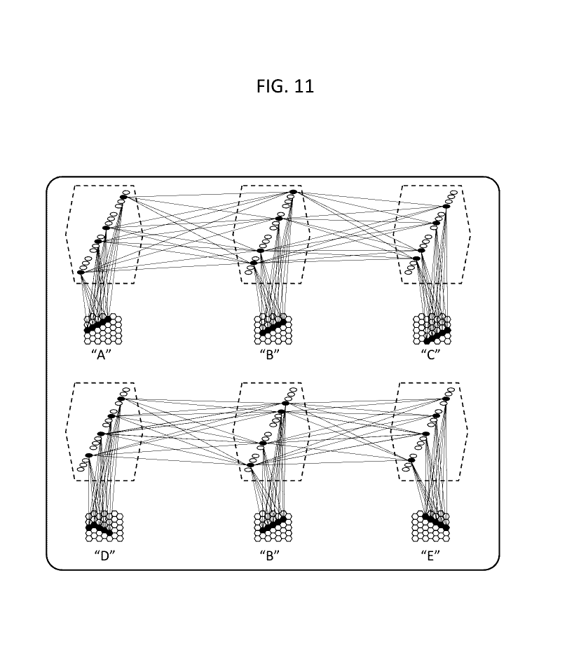

A computer model with the architecture of FIGS. 9 and 10 can store multiple sequences, in particular, multiple DBMTSs, even if one or more of the items appears, in possibly different contexts, in multiple of the stored sequences. For example, the two sequences, [ABC] and [DBE] could be stored in such an SDR mac, as shown in FIG. 11. Here the model has been “unrolled” in time. That is, each row of FIG. 11 shows the model at the three successive time steps (items) of the sequence and the H connections are shown as starting at time T and “recurring” back to the same mac at time T+1. Both stored sequences have the same middle item, “B”. The code for the first instance is denoted φ_{AB}, i.e., the code for B when it follows A and A was the start of the sequence, which is a specific moment in time. φ_{DB} is the code for another unique moment, the moment when item B follows D and D was the start of the sequence. Note that the code for B is different in the two instances. This is because Sparsey's method for assigning codes to inputs, i.e., to specific moments, is context-dependent, i.e., dependent on the history of inputs leading up to the current input. In the model of FIGS. 9-12, that historical context signal is carried in the signals that propagate in the H matrix from the code active on the prior time step. In more general embodiments as described above with respect to the back-off technique, historical context information is also carried in the D matrix arriving at a mac (though higher level macs and D-inputs from the higher level macs are not included so as to simplify describing the MCH-handling method).

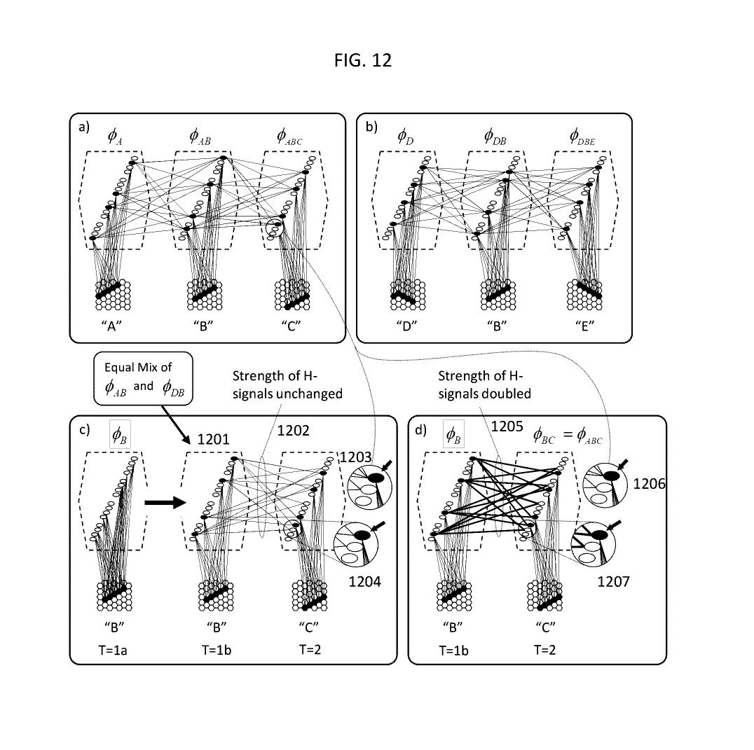

To motivate and explain the MCH-handling method it is useful to consider what would happen if the machine was presented with an ambiguous moment. As a special case of such ambiguity, suppose that the [ABC] and [DBE] are the only two sequences that have been stored in the mac and the item B is presented to the machine, as the start of a sequence. In this case, the machine will enter a state in which the code active in the mac is a superposition of the two codes that were assigned to the two moments when item B was the input. In fact in this case, since there is no reason to prefer one over the other, the two codes, φ_{AB} and φ_{DB} will have equal representation, i.e., strength, in the single active code. This is shown in FIG. 12C at time T=1 b 1201, where φ_{AB} and φ_{DB} are both 50% active.

Suppose the next item presented as input is item C, as shown in FIG. 12C at time T=2. In this case, it would be reasonable for the machine to enter an internal state consistent with the current sequence being an instance, albeit an erroneous instance, of the previously encountered sequence, [ABC], since there is sufficient information at T=2 to rule out that the sequence is an instance (albeit an erroneous one) of [DBE]. To enter that state means that the code chosen at T=2 should be identical to the code, φ_{ABC}, which was chosen on item 3 of the learning sequence [ABC]. To achieve that, the choice of winning unit in each CM must be the same as it was in that learning instance. In Sparsey, one method of making that choice is by turning the V vector over the units in a CM into a probability distribution and choosing a winner from that distribution (implemented in CSA Steps 8-12, see Table 1). This method of choosing is called “softmax”. In order to maximize the chance that the same unit, j, wins in the current instance as did in the learning instance, as much as possible of the probability mass should be allocated to j.

In CSA step 4, the V vector is computed as a product of normalized evidence factors, U and H. If the H value for unit j is 0.5, then the resulting V value for j can be at most 0.5. Although, the V vector is first transformed nonlinearly (CSA Steps 9 and 10) and renormalized, the fact that j's V is only 0.5 necessarily results in a flatter V distribution than if j's V=1.0. An MCH-handling technique in accordance with some embodiments is therefore a means for boosting the H signals originating from a mac in which an MCH condition existed to yield higher values for units, j, contained in the code(s) of hypotheses consistent with the input sequence. Doing so ultimately increases the probability mass allocated to such units and improves the chance of activating the entire code(s) of such consistent hypotheses.

In FIG. 12C, at time T=2, the lower yellow circle 1204 zooms in to display the incoming U (black lines) and H (green lines) signals arriving at two units in the bottom CM of the mac. The top unit in the CM (purple arrow) is the unit contained in the code φ_{ABC}, and thus is the unit that should win in this CM at time T=2. However, there are only two green lines impinging the unit, both of which originate from the two units active in φ_{B} (at time T=1), which are also contained in φ_{AB}. Compare this situation to that in the top yellow circle 1203, which shows the U and H signals arriving at this unit in the original learning instance (shown in FIG. 12A). In that case, there were four active H signals. Thus, in the current instance, the H signals provide only half the evidence that this unit should win than would be provided if the full code, φ_{AB}, was active at time T=1.

An MCH-handling technique in accordance with some embodiments multiplies the strengths of the outgoing signals from the active code at time T=1, in this case, from the code φ_{AB}, by the number of HLCHs, ζ, that exist in superposition in φ_{AB}. In this case, ζ=2; thus the weights are multiplied by 2. This is shown graphically, as thickened green lines 1205 in FIG. 12D. Thus, the total number of H signals impinging the unit (blue arrow in lower yellow circle 1207 of FIG. 12D) is still only two, but each of the signals is twice as strong. Thus the total evidence provided by the H signals in this instance (the lower yellow circle 1207 in FIG. 12D) is of the same strength as the total evidence provided in the learning instance (blue arrow in upper yellow circle 1206 of FIG. 12D). The result is that the H value computed for the unit j (blue arrow) will be 1.0, which then allows j's V value to be 1.0 (provided j's U value is also 1.0), and which ultimately improves j's chance of being chosen as the winner. Since the same learning and current input conditions exist in all four CMs, this also increases the chance that the entire code, φ_{ABC}, will be reactivated.

Although the above-described example specifically involves H signals coming from a mac in which an MCH condition existed, the same principles apply for any type of signals (U, H, or D) arriving from any mac and whether or not the source and destination mac is the same.

The specific CSA Steps involved in the MCH-handling technique described herein are given below (and also appear in Table 1). Some embodiments are directed to computing ζ for a mac that is the source of outgoing signals, e.g., to itself and/or other macs and for modulating those outgoing signals.

ζ_{q}=Σᵢ₌₀^{K}[V(i)>V_{ζ]} (Eq. 5a)

ζ=rni(Σⱼ₌₀^{Q-1}ζ_{q}/Q) (Eq. 5b)

Eq. 2b shows that H-signals are modulated by a function of the ζ on the previous time step. Equations 2a and 2c show similar modulation of signals emanating from macs in the RF_{U} and RF_{D}, respectively.

u(i)=Σ_{jεRF}_{_{U}}a(j,t)×F(ζ(j,t))×w(j,i) (Eq. 2a)

h(i)=Σ_{jεRF}_{_{H}}a(j,t−1)×F(ζ(j,t−1))×w(j,i) (Eq. 2b)

d(i)=Σ_{jεRF}_{_{D}}a(j,t−1)×F(ζ(j,t−1))×w(j,i) (Eq. 2c)

The example shown in FIG. 12 was simple in that it involved only two sequences having been learned, containing a total of six moments, [A], [AB], [ABC], [D], [DB], and [DBE], and very little pixel-wise overlap between the items. Thus, cross-talk between the stored codes was small. However, in general, macs will store far more codes and the overlap between the codes may be more substantial. If for example, the mac of FIG. 12 stored 10 moments when B was presented, then, when prompted with the item B as the first sequence item, almost all cells in all CMs may have V=1. As discussed in CSA Step 2, when the number of MCHs (ζ) in a mac gets too high, i.e., when the mac is muddled, its efferent signals will generally only serve to decrease SNR in target macs (including itself on the next time step via the recurrent H-wts) and so we disregard them. Specifically, when ζ is small, e.g., two or three, it is desirable to boost the value of the signals coming from all active cells in that mac by multiplying by ζ, or some other suitable factor, as discussed above. However, as ζ grows beyond that range, the expected overlap between the competing codes increases and to approximately account for that, the boost factor may be diminished, for example, in accordance with Eq. 6, where A is an exponent less than 1, e.g., 0.7. Further, once ζ reaches a threshold, B, which may be typically set to 3 or 4, the outgoing weights may be multiplied by 0, thus effectively disregarding the mac's outgoing signals completely in downstream computations. The correction factor for MCHs is denoted as F (ζ), defined as in Eq. 6. The notation, F (ζ(j,t)) as in Eq. 2 is also used, where ζ(j,t) is the number of hypotheses tied for maximal activation strength in the owning mac of a pre-synaptic cell, j, at time (frame) t.

$$F ( ζ ) = \{ \begin{matrix}{ζ}^{A} & 1 \leq ζ \leq B \\ 0 & ζ > B\end{matrix} \qquad ( Eq . 6 )$$

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification, unless clearly indicated to the contrary, should be understood to mean “at least one.”

The phrase “and/or,” as used herein in the specification should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the description above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The following definitions and synonyms are listed here for convenience while reading the Claims.

“Sequence”: a sequence of items of information, where each item is represented by a vector or array of binary or floating pt values, e.g., a 2D array of pixel values representing an image, a 1D vector of graded input summations to the units comprising a coding field.

“Input sequence”: a sequence presented to the invention, which the invention will recognize if it is similar enough to one of the sequences already stored in the memory module of the invention. “Similar enough” means similar enough under any of the large space of nonlinearly time warped versions of any already stored sequence that are implicitly defined by the backoff policy.

“Previously learned sequence”=“learned sequence”=“stored sequence”

“Time-warped instance of a previously learned sequence”: a sequence that is equal to a stored sequence by some schedule of local (in time, or in item index space) speedups (which in a discrete time domain manifest as deletions) and slowdowns (which in a discrete time domain manifest as repetitions). The schedule may include an arbitrary number of alternating speedups/slowdowns of varying durations and magnitudes.

“Memory module”=“SDR coding field”=“mac”

### REFERENCES

Ahmad, S. and J. hawkins (2015). “Properties of Sparse Distributed Representations and their Application to Hierarchical Temporal Memory.”
Cui, Y., C. Surpur, S. Ahmad and J. Hawkins (2015). “Continuous online sequence learning with an unsupervised neural network model.”
De Sousa Webber, F. E. (2014). Methods, apparatus and products for semantic processing of text, Google Patents.
Feldman, V. and L. G. Valiant (2009). “Experience-Induced Neural Circuits That Achieve High Capacity.” Neural Computation 21(10): 2715-2754.
Hawkins, J. C., M. I. I. Ronald, A. Raj and S. Ahmad (2016). Temporal Memory Using Sparse Distributed Representation, Google Patents.
Hawkins, J. C., C. Surpur and S. M. Purdy (2016). Sparse distributed representation of spatial-temporal data, Google Patents.
Hecht-Nielsen, R. (2005). “Cogent confabulation.” Neural Networks 18(2): 111-115.
Hecht-Nielsen, R. (2005). Confabulation Theory: A Synopsis. San Diego, UCSD Institute for Neural Computation.
Jazayeri, M. and J. A. Movshon (2006). “Optimal representation of sensory information by neural populations.” Nat Neurosci 9(5): 690-696.
Kanerva, P. (1988). Sparse distributed memory. Cambridge, Mass., MIT Press.
Kanerva, P. (2009). “Hyperdimensional Computing: An Introduction to Computing in Distributed Representation with High-Dimensional Random Vectors.” Cognitive Computing 1: 139-159.
Katz, S. M. (1987). “Estimation of probabilities from sparse data for the language model component of a speech recognizer.” IEEE Trans. on Acoustics, Speech, and Speech Processing 35: 400-401.
Moll, M. and R. Miikkulainen (1997). “Convergence-Zone Episodic Memory: Analysis and Simulations.” Neural Networks 10(6): 1017-1036.
Moll, M., R. Miikkulainen and J. Abbey (1993). The Capacity of Convergence-Zone Episodic Memory, The University of Texas at Austin, Dept. of Computer Science.
Olshausen, B. and D. Field (1996). “Emergence of simple-cell receptive field properties by learning a sparse code for natural images.” Nature 381: 607-609.
Olshausen, B. and D. Field (1996). “Natural image statistics and efficient coding.” Network: Computation in Neural Systems 7(2): 333-339.
Olshausen, B. A. and D. J. Field (2004). “Sparse coding of sensory inputs.” Current Opinion in Neurobiology 14(4): 481.
Pouget, A., P. Dayan and R. Zemel (2000). “Information processing with population codes.” Nature Rev. Neurosci. 1: 125-132.
Pouget, A., P. Dayan and R. S. Zemel (2003). “Inference and Computation with Population Codes.” Annual Review of Neuroscience 26(1): 381-410.
Rachkovskij, D. A. (2001). “Representation and Processing of Structures with Binary Sparse Distributed Codes.” IEEE Transactions on Knowledge and Data Engineering 13(2): 261-276.
Rinkus, G. (1996). A Combinatorial Neural Network Exhibiting Episodic and Semantic Memory Properties for Spatio-Temporal Patterns. Ph.D., Boston University.
Rinkus, G. (2012). “Quantum Computing via Sparse Distributed Representation.” NeuroQuantology 10(2): 311-315.
Rinkus, G. J. (2010). “A cortical sparse distributed coding model linking mini- and macrocolumn-scale functionality.” Frontiers in Neuroanatomy 4.
Rinkus, G. J. (2014). “Sparseŷ™: Spatiotemporal Event Recognition via Deep Hierarchical Sparse Distributed Codes.” Frontiers in Computational Neuroscience 8.
Sakoe, H. and S. Chiba (1978). “Dynamic programming algorithm optimization for spoken word recognition.” IEEE Trans. on Acoust., Speech, and Signal Process., ASSP 26: 43-49.
Snaider, J. (2012). “Integer sparse distributed memory and modular composite representation.”
Snaider, J. and S. Franklin (2011). Extended Sparse Distributed Memory. BICA.
Snaider, J. and S. Franklin (2012). “Extended sparse distributed memory and sequence storage.” Cognitive Computation 4(2): 172-180.
Snaider, J. and S. Franklin (2012). Integer Sparse Distributed Memory. FLAIRS Conference.
Snaider, J. and S. Franklin (2014). “Modular composite representation.” Cognitive Computation 6(3): 510-527.

1. A computer implemented method for recognizing an input sequence that is a time-warped instance of any of one or more previously learned sequences stored in a memory module M, where M represents information, i.e., the items of the sequences, using a sparse distributed representation (SDR) format, the method comprising:
a) for each successive item of the input sequence, activating a code in M, which represents the item in the context of the preceding items of the sequence, and
b) where M consists of a plurality of Q winner-take-all competitive modules (CMs), each consisting of K representational units (RUs) and the process of activating a code is carried out by choosing a winning RU (winner) in each CM, such that the chosen (activated) code consists of Q active winners, one per CM, and
c) where the process of choosing a winner in a CM involves first producing a probability distribution over the K units of the CM, and then choosing a winner either:
i) as a draw from the distribution (soft max), or
ii) by selecting the unit with the max probability (hard max).

2. The method of claim 1, wherein:
a) one or more sources of input to M are used in determining the code for the item, whereby we mean, more specifically, that the one or more input sources are used to generate the Q probability distributions, one for each of the Q CMs, from which the winners will be picked, and
b) if an input sequence is recognized as an instance of a stored sequence, S, then the code activated to represent the last item of the input sequence will be the same as or closest to the code of the last item of S, and
c) where the similarity measure over code space is intersection size.

3. The method of claim 2, wherein:
a) one or more of the input sources to M represents information about the current input item, referred to as the “U” source in the Detailed Description, and
b) one or more of the input sources to M represents information about the history of the sequence of items processed up to the current item, where two such sources were described in the Detailed Description,
i) one referred to as the “H” source, which carries information about the previous code active in M and possibly the previous codes active in additional memory modules at the same hierarchical level of an overall possibly multi-level network of memory modules, which by recursion, carries information about the history of preceding items from the start of the input sequence up to and including the previous item, and
ii) one referred to as the “D” source, which carries information about previous and or currently active codes in other higher-level memory modules, which also carry information about the history of the sequence thus far, and
iii) these H and D sources being instances of what is commonly referred to in the field as “recurrent” sources, and
c) where there can be arbitrarily many input sources, and where any of the sources, e.g., U, H, and D, may be further partitioned into different sensory modalities, e.g., the U source might be partitioned into a 2D vector representing an image at one pixel granularity and another 2D vector representing the image at another pixel granularity, both which supply signals concurrently to M.

4. The method of claim 3, wherein the use of the input sources to determine a code is a staged, conditional process, which we call the “Back-off” process, wherein, for each successive item of the input sequence:
a) a series of estimates of the familiarity, G, of the item is generated, where
b) the production of each estimate of G is achieved by multiplying a subset of all available input sources to M to produce a set of Q CM distributions of support values, i.e., “support distributions”, over the cells comprising each CM, and computing G as a particular measure on that set of support distributions, where in one embodiment that measure is the average maximum support value across the Q CMs, and where
c) we denote the estimate of G by subscripting it with the set of input sources used to compute it, e.g., G_{UD}, if U and D are used, G_{U} if only U is used, etc., and where
d) the estimate is then compared to a threshold, Γ, which may be specific to the set of sources used to compute it, e.g., compare G_{UD} to Γ_{UD}, compare G_{U} to Γ_{U}, etc., and where
e) if the threshold is attained, the G estimate is used to nonlinearly transform the set of Q support distributions (generated in step 4b) into a set of Q probability distributions (in Steps 9-11 of Table 1 of the Background section), from which the winners will be drawn, yielding the code, and
f) if the threshold is not attained, the process is repeated for the next G estimate in the prescribed series, proceeding to the end of the series if needed,

5. The method of claim 4, wherein the prescribed series will generally proceed from the G estimate that use all available input sources (the most stringent familiarity test), and then consider subsets of progressively smaller size (progressively less stringent familiarity tests), e.g., starting with G_{HUD}, then if necessary trying G_{HU} and G_{UD}, then if necessary trying G_{U} (note that not all possible subsets need be considered and the specific set of subsets tried and the order in which they are tried are prescribed and can depend on the particular application).

6. The method of claim 5, where M uses an alternative SDR coding format in which the entire field of R representational units is treated as a Z-winner-take-all (Z-WTA) field, where the choosing of a particular code is the process of choosing Z winners from the R units, where Z is much smaller R, e.g., 0.1%, 1%, 5%, and where in one embodiment, G would be defined as the average maximum value of the top Z values of the support distribution, and the actual choosing of the code would be either:
a) making Z draws w/o replacement from the single distribution over the R units comprising the field, or
b) choosing the units with the top Z probability values in the distribution.

7. A non-transitory computer readable storage medium storing instructions, which when executed implement the functionality described in claims 1-6.

8. The method of claim 3, where in determining the code to activate for item, T, of an input sequence,
a) for each of the Q CMs, 1 to q, the number, ζ_{q}, of units tied (or approximately tied, i.e., within a predefinable epsilon) for the maximal probability of winning in CM q, and where that maximal probability is within a threshold of 1/ζ_{q}, e.g., greater than 0.9×1/ζ_{q} (the idea being that the ζ_{q} units are tied for their chance of winning and that chance is significantly greater than the chances of any of the other K-ζ_{q} units in CM q), is computed, and where
b) the average, ζ, of ζ_{q} across the Q CMs, rounded to the nearest integer, is computed.

9. The method of claim 8, wherein if ζ≧2, i.e., if in all Q CMs, there are ζ tied units that are significantly more likely to win than the rest of the units, that indicates that, upon being presented with item T of the input sequence, ζ of the sequences stored in M, S₁ to S_{ζ}, are equally and maximally likely, i.e., one of the set of ζ maximally likely units in each CM is contained in the code of S₁, a different one of that set is in the code of S₂, etc., which we refer to as a “multiple competing hypotheses” (MCH) condition, and which is a fundamentally ambiguous condition given M's set of learned (stored) sequences and the current input sequence up to and including item T of the input sequence.

10. The method of claim 9, wherein when an MCH condition exists in M, the process of selecting winners is expected to result in the unit that was contained in S₁ being chosen (activated) in approximately 1/ζ of Q CMs, the unit that was contained in S₂, being chosen in different approximately 1/ζ of the Q CMs, . . . , the unit that was contained in S_{ζ} being chosen in a further different 1/ζ of the Q CMs; in other words, the ζ equally and maximally likely hypotheses, i.e., the hypothesis that the input sequence up to and including item T is the same as stored sequence S₁, that it is the same as stored sequence S₂, . . . , that it is the same as the stored sequence S_{ζ}, are physically represented by a 1/ζ fraction of their codes being simultaneously active (modulo variances).

11. The method of claim 10, wherein outgoing signals from the active units comprising the code active in M at T are multiplied in strength by ζ.

12. The method of claim 11, where M uses an alternative SDR coding format in which the entire field of R representational units is treated as a Z-WTA field, where the choosing of a particular code is the process of choosing Z winners from the R units, where Z is much smaller R, e.g., 0.1%, 1%, 5%, and where in one embodiment, the process of choosing a code is to make Z draws w/o replacement from the single distribution over the R units, in which case, if an MCH condition exists in M, then that selection process is expected to result in the unit that was contained in S₁ being chosen (activated) in approximately 1/ζ of Q CMs, the unit that was contained in S₂, being chosen in different approximately 1/ζ of the Q CMs, . . . , the unit that was contained in S_{ζ} being chosen in a further different 1/ζ of the Q CMs, and in which case, the outgoing signals from the active units comprising the code active in M at T are multiplied in strength by ζ.

13. A non-transitory computer readable storage medium storing instructions, which when executed implement the functionality described in claims 1-3 and 8-12.
